(19) United States
(12) Patent Application Publication
(10) Pub. No.: US 2025/0292123 A1
(43) Pub. Date: Sep. 18, 2025

(54) APPARATUS AND METHOD FOR UNSTRUCTURED DATA ANALYSIS BASED ON ARTIFICIAL INTELLIGENCE

(71) Applicant: GAZZILABS, INC., Seoul (KR)

(72) Inventor: Ki Ok AHN, Suwon-si (KR)

(21) Appl. No.: 19/224,949

(22) Filed: Jun. 2, 2025

Related U.S. Application Data
(63) Continuation of application No. PCT/KR2024/001665, filed on Feb. 5, 2024.

(30) Foreign Application Priority Data
Mar. 20, 2023 (KR) 10-2023-0035926
Aug. 14, 2023 (KR) 10-2023-0106326

(51) Int. Cl. G06N 5/045; G06N 5/02

(52) U.S. Cl. CPC G06N 5/045; G06N 5/02

(57) ABSTRACT

An apparatus and method for unstructured data analysis based on artificial intelligence are disclosed, and a method for unstructured data analysis based on artificial intelligence according to one embodiment of the present disclosure may include (a) identifying an object existing in unstructured data and recognizing attributes of the object, (b) defining a scene representation for the unstructured data based on the object and the attributes, (c) generating a graph corresponding to the scene representation by using a pre-constructed ontology knowledge base, and (d) inputting the graph to a pre-trained graph classification model so as to derive analysis information including at least one of situation recognition information and predictive behavior information reflected in the unstructured data.

### CROSS-REFERENCE TO RELATED APPLICATIONS

This application claims the priority of Korean Patent Application No. 10-2023-0035926 filed on Mar. 20, 2023, and Korean Patent Application No. 10-2023-0106326 filed on Aug. 14, 2023, and PCT/KR2024/001665 February 05, 2024 in the Korean Intellectual Property Office, the disclosure of which is incorporated herein by reference.

### BACKGROUND

### Field

The present disclosure relates to an apparatus and method for unstructured data analysis based on artificial intelligence. For example, the present disclosure relates to an explainable artificial intelligence-based analysis technique that combines a neural network and symbolic artificial intelligence.

### Description of the Related Art

A neural network and symbolic artificial intelligence have developed into different types of artificial intelligence.

First, the neural network is an algorithm that has advantages in analyzing unstructured data, and has been established as a mainstream algorithm in the computer vision field of image recognition and classification today, to the point that the neural network has won the top prize in the ImageNet large scale visual recognition challenge since 2015. Recently, technology for inference using the neural network has emerged, but there is a problem that enormous costs are required to train and operate ultra-large neural networks.

In addition, symbolic artificial intelligence is an expert system, and IBM's Watson has been representative of its effectiveness, and the symbolic artificial intelligence manages the rules, intelligence knowledge base, and knowledge graph required for artificial intelligence in RDF format and proceeds with the concept of graph extension through inference. However, the symbolic artificial intelligence has a disadvantage in that it is difficult to contain all the knowledge of the world, so although it can improve the recognition rate to a certain extent, it is difficult to improve the performance further.

The technology that forms the background of the present disclosure is disclosed in Korean Patent No. 10-0813925.

### SUMMARY

The present disclosure is intended to solve the problems of the above-mentioned conventional technology, and an object thereof is to provide an apparatus and method for unstructured data analysis based on artificial intelligence capable of solving the problem of enormous costs required for training and operating a super-large neural network.

The present disclosure is intended to solve the problems of the above-mentioned conventional technology, and an object thereof is to provide an apparatus and method for unstructured data analysis based on artificial intelligence capable of solving the problem of difficulty in improving the recognition rate of symbolic artificial intelligence beyond a certain level.

However, the technical tasks that the present disclosure seeks to accomplish are not limited to the technical tasks described above, and other technical tasks may exist.

As a technical means for achieving the above technical task, a method for unstructured data analysis based on artificial intelligence according to one embodiment of the present disclosure may include: (a) identifying an object existing in unstructured data and recognizing attributes of the object; (b) defining a scene representation for the unstructured data based on the object and the attributes; (c) generating a graph corresponding to the scene representation by using a pre-constructed ontology knowledge base; and (d) inputting the graph to a pre-trained graph classification model so as to derive analysis information including at least one of situation recognition information and predictive behavior information reflected in the unstructured data.

According to one embodiment of the present disclosure, in the (b), the attributes may be reflected in the scene representation based on a data type including at least one of a resource description framework (RDF), N-Tripe, and a table.

According to one embodiment of the present disclosure, the method for unstructured data analysis based on artificial intelligence may further include updating the scene representation based on the analysis information.

According to one embodiment of the present disclosure, the method for unstructured data analysis based on artificial intelligence may further include reflecting the scene representation updated using the analysis information into the ontology knowledge base.

According to one embodiment of the present disclosure, the method for unstructured data analysis based on artificial intelligence may further include (e) receiving a user search input, searching for the analysis information corresponding to the user search input from the ontology knowledge base, and providing partial data of the unstructured data matching the user search input.

According to one embodiment of the present disclosure, the unstructured data may include image data including a plurality of frames, and the (a) to (d) may be performed independently for each of the plurality of frames.

According to one embodiment of the present disclosure, the unstructured data may include image data, and the partial data may include a summary image or a description image that matches the user search input.

According to one embodiment of the present disclosure, an apparatus for unstructured data analysis based on artificial intelligence may include: an object attribute recognition unit that identifies an object existing in unstructured data and recognizes attributes of the object; a knowledge representation unit that defines a scene representation for the unstructured data based on the object and the attributes; a graph generation unit that generates a graph corresponding to the scene representation by using a pre-constructed ontology knowledge base; and a graph analysis unit that inputs the graph to a pre-trained graph classification model so as to derive analysis information including at least one of situation recognition information and predictive behavior information reflected in the unstructured data.

According to one embodiment of the present disclosure, the knowledge representation unit may reflect the attributes in the scene representation based on a data type including at least one of a resource description framework (RDF), N-Triple, and a table.

According to one embodiment of the present disclosure, the knowledge representation unit may update the scene representation based on the analysis information.

According to one embodiment of the present disclosure, the apparatus for unstructured data analysis based on artificial intelligence may further include an ontology management unit that reflects the scene representation updated using the analysis information into the ontology knowledge base.

According to one embodiment of the present disclosure, the apparatus for unstructured data analysis based on artificial intelligence may further include a search performing unit that receives a user search input, searches for the analysis information corresponding to the user search input from the ontology knowledge base, and provides partial data of the unstructured data matching the user search input.

According to one embodiment of the present disclosure, the unstructured data may include image data including a plurality of frames.

According to one embodiment of the present disclosure, the unstructured data may include image data, and the partial data may include a summary image or a description image that matches the user search input.

The solution to the above-described problems is merely exemplary and should not be construed as limiting the present disclosure. In addition to the above-described exemplary embodiments, additional embodiments may exist in the drawings and detailed description of the disclosure.

According to the solution to the above-described problem of the present disclosure, by providing an apparatus and method for unstructured data analysis based on artificial intelligence that combines a neural network that has an advantage in unstructured data application and a symbolic artificial intelligence that has an advantage in inference, there is an effect in which resource management for unstructured data analysis and inference by artificial intelligence can be performed efficiently.

According to the solution to the problem of the present disclosure described above, by providing an apparatus and method for unstructured data analysis based on artificial intelligence, there is an effect of solving the problem of difficulty in improving the recognition rate of the symbolic artificial intelligence beyond a certain level.

According to the solution to the above-described problem, by providing an apparatus and method for unstructured data analysis based on artificial intelligence, it is possible to solve the problem of difficulty in improving the recognition rate of symbolic artificial intelligence beyond a certain level.

However, the effects that can be obtained from the present disclosure are not limited to the effects described above, and other effects may exist.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a schematic diagram of a system for unstructured data analysis based on artificial intelligence according to one embodiment of the present disclosure.

FIG. 2 is a schematic diagram of an apparatus for unstructured data analysis based on artificial intelligence according to one embodiment of the present disclosure.

FIG. 3 is a diagram schematically illustrating an example of application of a method for unstructured data analysis based on artificial intelligence for sport group behavior recognition according to one embodiment of the present disclosure.

FIG. 4 is a diagram schematically illustrating the experimental results for an example of application of the method for unstructured data analysis based on artificial intelligence for the sport group behavior recognition according to one embodiment of the present disclosure.

FIG. 5 is a diagram schematically illustrating an example of application of a method for unstructured data analysis based on artificial intelligence for autonomous traveling according to one embodiment of the present disclosure.

FIG. 6 is a diagram schematically illustrating the experimental results for the example of the application of the method for unstructured data analysis based on artificial intelligence for the autonomous traveling according to one embodiment of the present disclosure.

FIG. 7 is a diagram schematically illustrating an example of ontology application of the method for unstructured data analysis based on artificial intelligence according to one embodiment of the present disclosure.

FIG. 8 is a diagram schematically illustrating a first data visualization example corresponding to the ontology application of the method for unstructured data analysis based on artificial intelligence according to one embodiment of the present disclosure.

FIG. 9 is a diagram schematically illustrating a second data visualization example corresponding to the ontology application of the method for unstructured data analysis based on artificial intelligence according to one embodiment of the present disclosure.

FIG. 10 is a flowchart of an operation method for controlling the apparatus for unstructured data analysis based on artificial intelligence according to one embodiment of the present disclosure.

### DETAILED DESCRIPTION OF THE EMBODIMENT

Below, with reference to the attached drawings, the embodiments of the present disclosure are described in detail so that those with ordinary knowledge in the technical field to which the present disclosure pertains can easily practice them. However, the present disclosure may be implemented in various different forms and is not limited to the embodiments described herein. In addition, in order to clearly describe the present disclosure in the drawings, parts that are not related to the description are omitted, and similar parts are given similar drawing reference numerals throughout the specification.

Throughout the present specification, when a part is said to be “connected” to another part, this includes not only cases where it is “directly connected”, but also cases where it is “electrically connected” or “indirectly connected” with another element in between.

Throughout the present specification, when it is said that an element is located “on”, at an “upper portion of”, at an “upper end of”, “below”, at a “lower portion of”, or at a “lower end” of another element, this includes not only cases where an element is in contact with another element, but also cases where another element exists between the two elements.

Throughout the present specification, whenever a part is said to “include” a component, this does not mean that it excludes other components, but rather that it may include other components, unless otherwise specifically stated.

The present disclosure relates to an apparatus and method for unstructured data analysis based on artificial intelligence. For example, the present disclosure relates to an explainable artificial intelligence-based analysis technique that combines a neural network and symbolic artificial intelligence.

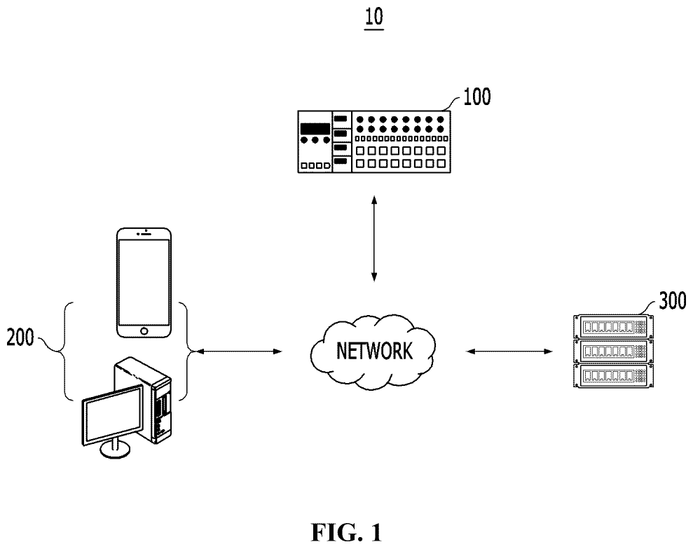

FIG. 1 is a schematic diagram of a system for unstructured data analysis based on artificial intelligence according to one embodiment of the present disclosure.

Referring to FIG. 1, a system 10 for unstructured data analysis based on artificial intelligence (hereinafter, also referred to as the “present system 10”) may include an apparatus 100 (hereinafter, also referred to as the “present apparatus 100”) for unstructured data analysis based on artificial intelligence, a user terminal 200, and an external server 300.

For example, according to the present system 10, the present apparatus 100 may identify an object existing in unstructured data and recognize attributes of the identified object, define a scene representation for the unstructured data based on the object and the attributes, generate a graph corresponding to the defined scene representation by using a pre-constructed ontology knowledge base, and input the generated graph to a pre-trained graph classification model so as to derive analysis information corresponding to the unstructured data.

The present apparatus 100 may receive unstructured data from the user terminal 200. In addition, the training data of the graph classification model may be received by the present apparatus 100 from the external server 300. The ontology knowledge base may be built in the present apparatus 100 or the external server 300.

The present apparatus 100, the user terminal 200, and the external server 300 may communicate with each other through a network. The network refers to a connection structure in which information can be exchanged between nodes, such as terminals and servers, and examples of such networks include, but are not limited to, a 3rd generation partnership project (3GPP) network, a long term evolution (LTE) network, a 5G network, a world interoperability for microwave access (WIMAX) network, the Internet, a local area network (LAN), a wireless local area network (wireless LAN), a wide area network (WAN), a personal area network (PAN), a Wi-Fi network, a Bluetooth network, a satellite broadcasting network, an analog broadcasting network, a digital multimedia broadcasting (DMB) network, or the like.

The user terminal 200 may be any type of wireless communication device, such as a smartphone, a smart pad, a tablet PC, a personal communication system (PCS), a global system for mobile communication (GSM), a personal digital cellular (PDC), a personal handyphone system (PHS), a personal digital assistant (PDA), an international mobile telecommunication (IMT)-2000, a code division multiple access (CDMA)-2000, a W-code division multiple access (W-CDMA), or a wireless broadband Internet (WiBro) terminal.

The external server 300 is a wireless communication device or a storage device and may be connected to the present apparatus 100 and the external server 300 via a network.

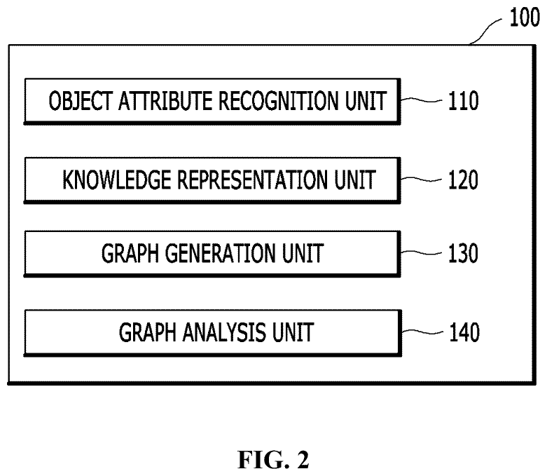

FIG. 2 is a schematic diagram of the apparatus 100 for unstructured data analysis based on artificial intelligence according to one embodiment of the present disclosure.

Referring to FIG. 2, the present apparatus 100 may include an object attribute recognition unit 110, a knowledge representation unit 120, a graph generation unit 130, and a graph analysis unit 140. In addition, although not illustrated in FIG. 2, the present apparatus 100 includes an ontology management unit and a search performing unit, but is not limited thereto.

According to one embodiment of the present disclosure, the present apparatus 100 may identify the object existing in unstructured data.

For example, when the present apparatus 100 inputs the unstructured data into the neural network and the neural network outputs an identification result for the object existing in the unstructured data, the present apparatus 100 may identify the object existing in the unstructured data based on the output identification result for the object. Here, the neural network may train the unstructured data and the object existing in the unstructured data. The neural network may be stored in the present apparatus 100 or in an external server 300. For example, when the present apparatus 100 receives the unstructured data from the user terminal 200, the present apparatus 100 transmits the unstructured data to an external server 300, the neural network equipped in the external server 300 uses the received unstructured data as input to output an object identification result existing in the unstructured data, the present apparatus 100 receives the object identification result from the external server 300, and finally, the present apparatus 100 may identify the object existing in the unstructured data based on the received object identification result. For example, the unstructured data may include images, videos, or the like.

According to one embodiment of the present disclosure, the present apparatus 100 may recognize the attributes of the object.

For example, when the present apparatus 100 inputs the object identification result existing in the unstructured data into the neural network and the neural network outputs a recognition result (hereinafter, “first object attribute recognition result”) for the attributes of the identified object, the present apparatus 100 may recognize the attribute of the object identified as existing in the unstructured data based on the first object attribute recognition result. Here, the neural network may train the unstructured data, the object existing in the unstructured data, and the first attribute of the object existing in the unstructured data. However, the present disclosure is not limited thereto, and the neural network may further train the n-th attribute of the object (n is a natural number greater than or equal to 2). The neural network may be stored in the present apparatus 100 or in the external server 300. For example, the object identification result output by the neural network may be input again under the control of the present apparatus 100 to output a first object attribute recognition result. In addition, the first object attribute recognition result output by the neural network may be input again under the control of the present apparatus 100 to output a second object attribute recognition result. In addition, an (n−1)-th object attribute recognition result output by the neural network may be input again under the control of the present apparatus 100 to output an n-th object attribute recognition result. The present apparatus 100 receives the first object attribute recognition result to the n-th object attribute recognition result from the external server 300, and finally, the present apparatus 100 may recognize the attributes of the object identified as existing in the unstructured data based on the received first object attribute recognition result to n-th object attribute recognition result. For example, the first object attribute may include the shape of the object, such as a sphere, and the second object attribute may include the color of the object, such as blue.

According to one embodiment of the present disclosure, the present apparatus 100 may define a scene representation for the unstructured data based on objects and attributes.

For example, the present apparatus 100 may implement a process of identifying the object existing in the unstructured data through the neural network and a process of recognizing the attribute of the object identified as existing in the unstructured data through the neural network in a preset language such as RDF or N-Triple Type and a preset table format, output the processes to a user interface of a web or application provided to the user terminal 200, and define the scene representation for the unstructured data by applying the implementation contents to the entire image.

According to one embodiment of the present disclosure, the present apparatus 100 may generate the graph corresponding to the scene representation using the pre-constructed ontology knowledge base.

For example, the present apparatus 100 may generate the graph corresponding to the scene representation implemented in a preset language and a preset table format using a pre-constructed ontology knowledge base. In addition, the present apparatus 100 may generate an extended graph by repeatedly extending the graph corresponding to the scene representation implemented in the preset table format and the language including the RDF and N-Triple Type generated through the ontology knowledge base based on inference.

According to one embodiment of the present disclosure, the present apparatus 100 may input the graph into the pre-trained graph classification model to derive analysis information including at least one of situation recognition information and predictive behavior information reflected in unstructured data.

For example, when the present apparatus 100 inputs an extended graph to a pre-trained graph classification model and the graph classification model outputs at least one of the situation recognition information and the predictive behavior information reflected in the unstructured data, the present apparatus 100 may derive the analysis information including at least one of the situation recognition information and the predictive behavior information reflected in the unstructured data based on at least one of the output situation recognition information and the output predictive behavior information. In addition, the present apparatus 100 may provide the derived analysis information to the user interface of the application or web provided to the user terminal 200. In addition, the present apparatus 100 may combine the derived analysis information with the ontology knowledge base. In addition, the present apparatus 100 performs an integration process of combining the analysis information with the scene representation and combining the analysis information with the ontology knowledge base, and when there is a problem in the integration process, the present apparatus 100 may reconstruct the integrated graph generated in the integration process into a decision tree from the input to the output, and explain the object identification and attribute recognition process based on the reconstructed decision tree through the user interface. Additionally, the present apparatus 100 may enable the results of the integration process to be retrieved using a query from a user interface including an ontology management program. For example, the present apparatus 100 may enable the results of scene behaviors to be retrieved through the user interface and summarize the results of the scene behaviors.

According to one embodiment of the present disclosure, the present apparatus 100 may reflect the attributes in the scene representation based on the data type including at least one of the resource description framework (RDF), N-Triple, and a table.

For example, the present apparatus 100 may reflect the attributes of the object in the scene representation implemented as the language including the RDF and N-Triple Type and the data type including the preset table format.

According to one embodiment of the present disclosure, the present apparatus 100 may update the scene representation based on the analysis information.

For example, when the extended graph is input to the pre-trained graph classification model and the graph classification model outputs at least one of the situation recognition information and the predictive behavior information reflected in the unstructured data, the present apparatus 100 may derive the analysis information including at least one of the situation recognition information and predictive behavior information reflected in the unstructured data based on at least one of the output situation recognition information and the output predictive behavior information, and update the scene representation based on the derived analysis information and provide the result to the user interface of the application or web provided to the user terminal 200.

According to one embodiment of the present disclosure, the present apparatus 100 may reflect the updated scene representation using the analysis information into the ontology knowledge base.

For example, when the extended graph is input to the pre-trained graph classification model and the graph classification model outputs at least one of the situation recognition information and predictive behavior information reflected in the unstructured data, the present apparatus 100 may derive the analysis information including at least one of the situation recognition information and predictive behavior information reflected in the unstructured data based on at least one of the output situation recognition information and the output predictive behavior information, update the scene representation based on the derived analysis information, provide the updated scene representation to the user interface of the application or web provided to the user terminal 200, and combine the updated scene representation with the ontology knowledge base.

According to one embodiment of the present disclosure, the present apparatus 100 may receive a user search input.

As an example, the present apparatus 100 may receive the user search input entered into the user interface provided on the user terminal 200.

According to one embodiment of the present disclosure, the present apparatus 100 may search for the analysis information corresponding to the user search input from the ontology knowledge base and provide partial data of the unstructured data matching the user search input.

For example, the present apparatus 100 may search for the analysis information corresponding to the user search input entered into the user interface provided on the user terminal 200 from the ontology knowledge base and provide the partial data of the unstructured data matching the user search input to the user interface provided on the user terminal 200.

According to one embodiment of the present disclosure, the unstructured data may include image data including a plurality of frames.

For example, the present apparatus 100 may receive the unstructured data including the image data including the plurality of frames, group frames within a preset similarity range among the plurality of frames, and leave only a preset number of frames among the grouped plurality of frames and delete the rest, to generate a reduced plurality of frames.

According to one embodiment of the present disclosure, the present apparatus 100 may be independently performed for each of the plurality of frames.

For example, the present apparatus 100 may identify the object existing in each of the plurality of frames included in the image data included in the unstructured data, recognize the attributes of the identified object, and define the scene representation for each of the plurality of frames based on the identified object and the recognized attributes.

As another example, the present apparatus 100 may identify the object existing in each of the reduced plurality of frames, recognize the attributes of the identified object, and define the scene representation for each of the reduced plurality of frames based on the identified objects and recognized attributes.

According to one embodiment of the present disclosure, the unstructured data may include the image data.

For example, the unstructured data may include the image data that includes the reduced plurality of frames.

According to one embodiment of the present disclosure, the partial data may include a summary image or a description image that matches the user search input.

For example, the present apparatus 100 may generate the partial data including the summary image or description image based on the analysis information corresponding to a reduced plurality of frames, and provide the partial data including the summary image or description image corresponding to the user search input to the user interface.

According to one embodiment of the present disclosure, the object attribute recognition unit 110 may identify the object existing in the unstructured data.

According to one embodiment of the present disclosure, the object attribute recognition unit 110 may recognize the attributes of the object.

According to one embodiment of the present disclosure, the knowledge representation unit 120 may define the scene representation for the unstructured data based on the object and attributes.

According to one embodiment of the present disclosure, the graph generation unit 130 may generate a graph corresponding to the scene representation using the pre-constructed ontology knowledge base.

According to one embodiment of the present disclosure, the graph analysis unit 140 may input the graph into the pre-trained graph classification model to derive the analysis information including at least one of the situation recognition information and predictive behavior information reflected in the unstructured data.

According to one embodiment of the present disclosure, the knowledge representation unit 120 may reflect the attributes in the scene representation based on a data type including at least one of the resource description framework (RDF), N-Triple, and a table.

According to one embodiment of the present disclosure, the knowledge representation unit 120 may update the scene representation based on the analysis information.

According to one embodiment of the present disclosure, the ontology management unit may reflect the updated scene representation into the ontology knowledge base using the analysis information.

According to one embodiment of the present disclosure, the search performing unit may receive the user search input.

According to one embodiment of the present disclosure, the search performing unit may search for the analysis information corresponding to a user search input from the ontology knowledge base and provide the partial data of unstructured data matching the user search input.

According to one embodiment of the present disclosure, the unstructured data may include the image data including the plurality of frames.

According to one embodiment of the present disclosure, the unstructured data may include the image data.

According to one embodiment of the present disclosure, the partial data may include the summary image or the description image that matches the user search input.

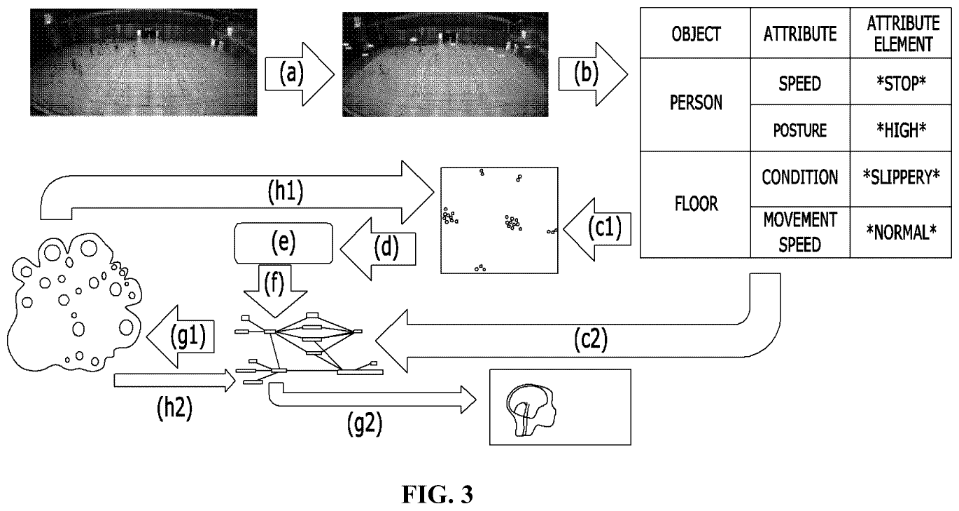

FIG. 3 is a diagram schematically illustrating an example of application of a method for unstructured data analysis based on artificial intelligence for sport group behavior recognition according to one embodiment of the present disclosure.

Referring to (a) of FIG. 3, the present apparatus 100 may detect the object from the unstructured data corresponding to a sport situation, and use YoloV5. In addition, referring to (b) of FIG. 3, the present apparatus 100 may recognize the attributes based on the detected object, and use Attnet. In this case, the attributes of the object may be configured as a table. In addition, referring to (c1) of FIG. 3, the present apparatus 100 may express a scene as a knowledge graph, and the expressed knowledge graph is a graph for learning, and may use the TUD format. In addition, referring to (c2) of FIG. 3, the present apparatus 100 may input the object and attributes into an RDF data model so that a graph based on an N-Triple Type is output. In addition, referring to (d) of FIG. 3, the present apparatus 100 may perform group behavior classification based on the knowledge graph, and use HGP-SL. In addition, referring to (e) of FIG. 3, sport group behavior may be classified as a result of the group behavior classification performed by the present apparatus 100. In addition, referring to (f) of FIG. 3, the present apparatus 100 may perform RDF processing on the sport group behavior to generate a graph based on the N-Triple Type. In addition, referring to (g1) of FIG. 3, the present apparatus 100 may generate a knowledge graph based on the ontology knowledge base based on the graph based on N-triple Type, and use Cayley. Through this, the present apparatus 100 may express the entire game centered on sport group behavior as a knowledge graph. Referring to (g2) of FIG. 3, the present apparatus 100 may generate a summary image centered on a specific scene based on the graph based on N-triple Type, and explain a specific scene corresponding to the summary image based on the generated summary image and explainable artificial intelligence (Xartificial intelligence (XAI)). For example, the summary image may be an image corresponding to a goal scene-centered game summary. In addition, referring to (h1) of FIG. 3, the present apparatus 100 may reflect the knowledge graph based on the ontology knowledge base to a knowledge graph for scene-based learning. In this case, the present apparatus 100 may use the ontology knowledge base. In addition, referring to (h2) of FIG. 3, the present apparatus 100 may perform group behavior search on an N-Triple Type graph based on the knowledge graph based on the ontology knowledge base.

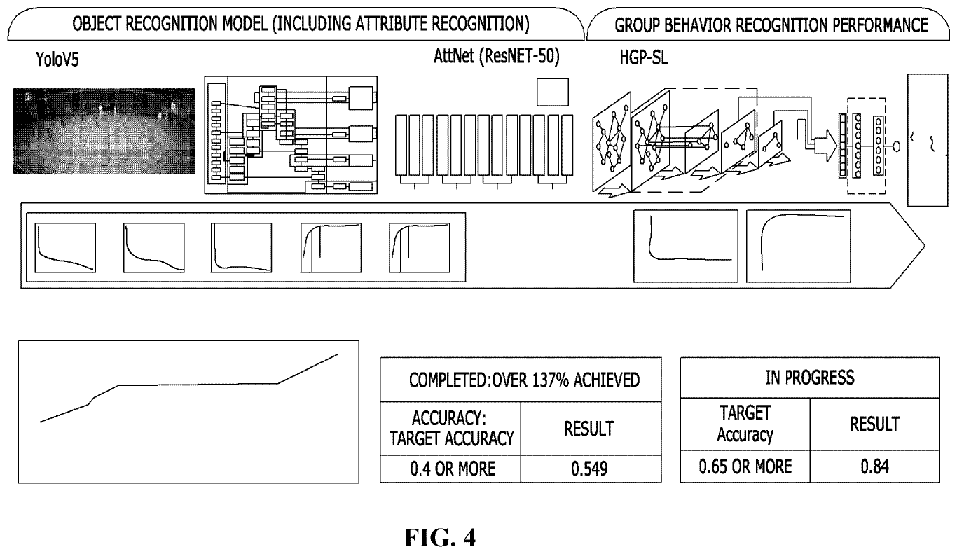

FIG. 4 is a diagram schematically illustrating the experimental results for an example of application of the method for unstructured data analysis based on artificial intelligence for the sport group behavior recognition according to one embodiment of the present disclosure.

Referring to FIG. 4, it can be confirmed that the accuracy of object and attribute recognition of the sport situation by the method for unstructured data analysis based on artificial intelligence performed by the present apparatus 100 records a result of 0.549, which exceeds the target accuracy of 0.4. In addition, it can be confirmed that the performance of group behavior recognition (accuracy of analysis information) of the sport situation by the method for unstructured data analysis based on artificial intelligence performed by the present apparatus 100 records a result of 0.84, which exceeds the target accuracy of 0.65. Therefore, the method for unstructured data analysis based on artificial intelligence performed by the present apparatus 100 may have an excellent effect in recognizing sport group behaviors.

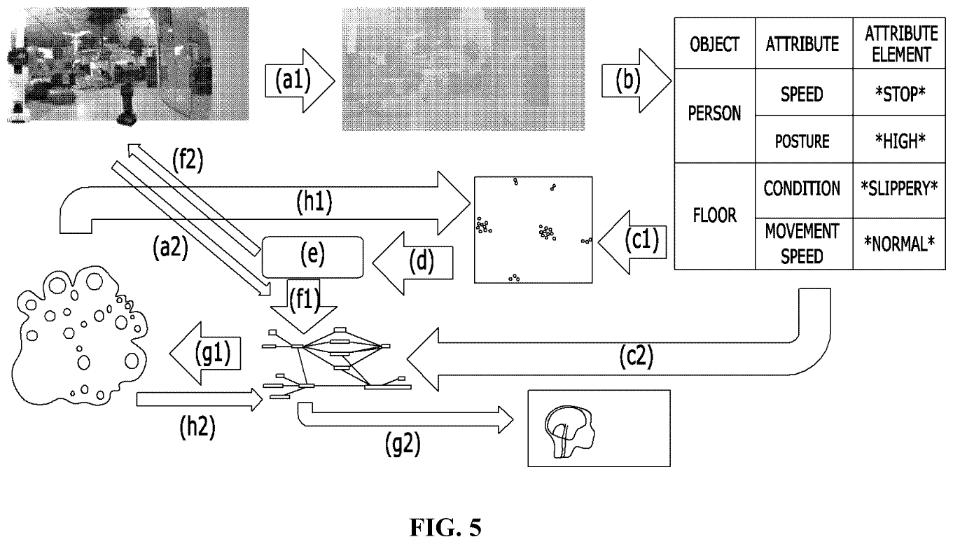

FIG. 5 is a diagram schematically illustrating an example of application of a method for unstructured data analysis based on artificial intelligence for autonomous traveling according to one embodiment of the present disclosure.

Referring to (a1) of FIG. 5, the present apparatus 100 may detect the object from the unstructured data corresponding to autonomous traveling, and use YoloV7. In addition, referring to (b) of FIG. 5, the present apparatus 100 may recognize attributes based on the detected object, and use Attnet. In this case, the attributes of the object may be configured as a table. In addition, referring to (c1) of FIG. 5, the present apparatus 100 may express the scene as the knowledge graph, and the expressed knowledge graph is a graph for learning, and use the TUD format. In addition, referring to (c2) of FIG. 5, the present apparatus 100 may input the object and attributes into an RDF data model so that the graph based on an N-Triple Type is output. In addition, referring to (d) of FIG. 5, the present apparatus 100 may perform predictive behavior classification based on the knowledge graph, and use HGP-SL. In addition, referring to (e) of FIG. 5, the autonomous traveling predicted behavior may be classified as the result of the predicted behavior classification performed by the present apparatus 100. In addition, referring to (f1) of FIG. 5, the present apparatus 100 may perform RDF processing on the autonomous traveling predicted behavior to generate a graph based on N-Triple Type. In addition, referring to (f2) of FIG. 5, the present apparatus 100 may control the moving member of the autonomous traveling to execute the autonomous traveling predicted behavior. Moreover, referring to (a2) of FIG. 5, the present apparatus 100 may reflect the unstructured data corresponding to the result of execution of predicted behavior including normal or accident, to the RDF processing for the autonomous traveling predicted behavior to generate the graph based on N-Triple Type. In addition, referring to (g1) of FIG. 5, the present apparatus 100 may generate the knowledge graph based on the ontology knowledge base based on the graph based on N-Triple Type, and use Cayley. Referring to (g2) of FIG. 5, the present apparatus 100 may generate the description image centered on an accident predicted behavior according to a specific scene situation based on the graph based on the N-Triple Type, and explain a specific scene corresponding to the description image based on the generated description image and explainable artificial intelligence (XAI). In addition, referring to (h1) of FIG. 5, the present apparatus 100 may reflect the knowledge graph based on the ontology knowledge base to the knowledge graph for scene-based learning. In this case, the present apparatus 100 may use the ontology knowledge base. In addition, referring to (h2) of FIG. 5, the present apparatus 100 may perform an accident search on a graph of an N-Triple Type based on the knowledge graph based on the ontology knowledge base.

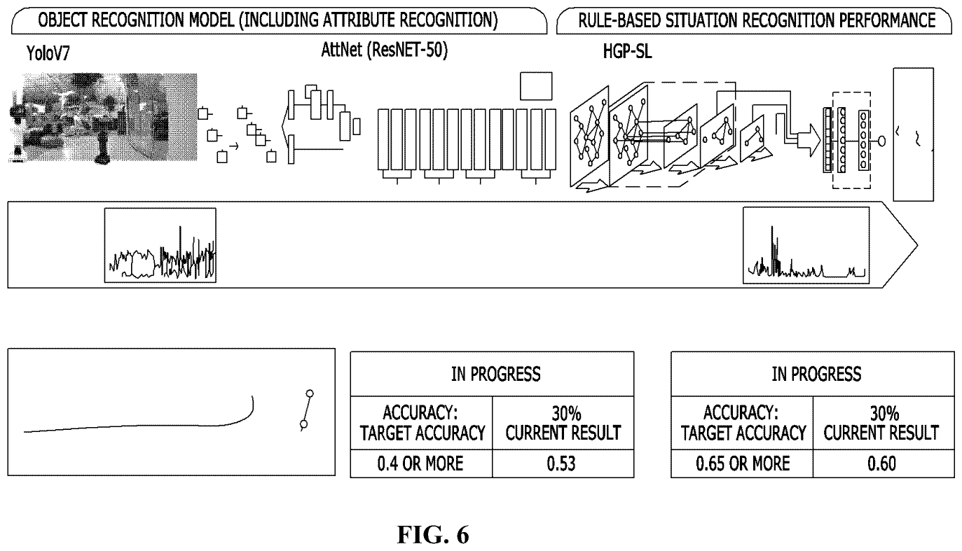

FIG. 6 is a diagram schematically illustrating the experimental results for the example of the application of the method for unstructured data analysis based on artificial intelligence for the autonomous traveling according to one embodiment of the present disclosure.

Referring to FIG. 6, it can be confirmed that the accuracy of object and attribute recognition in an autonomous traveling situation of the method for unstructured data analysis based on artificial intelligence performed by the present apparatus 100 records a result of 0.53, which exceeds the target accuracy of 0.4. In addition, it can be confirmed that the rule-based situation recognition performance (accuracy of analysis information) in the autonomous traveling situation of the method for unstructured data analysis based on artificial intelligence performed by the present apparatus 100 records a result of 0.60, which is close to the target accuracy of 0.65. Therefore, the method for unstructured data analysis based on artificial intelligence performed by the present apparatus 100 may have a good effect in the object and attribute recognition and rule-based situation recognition in the autonomous traveling situation.

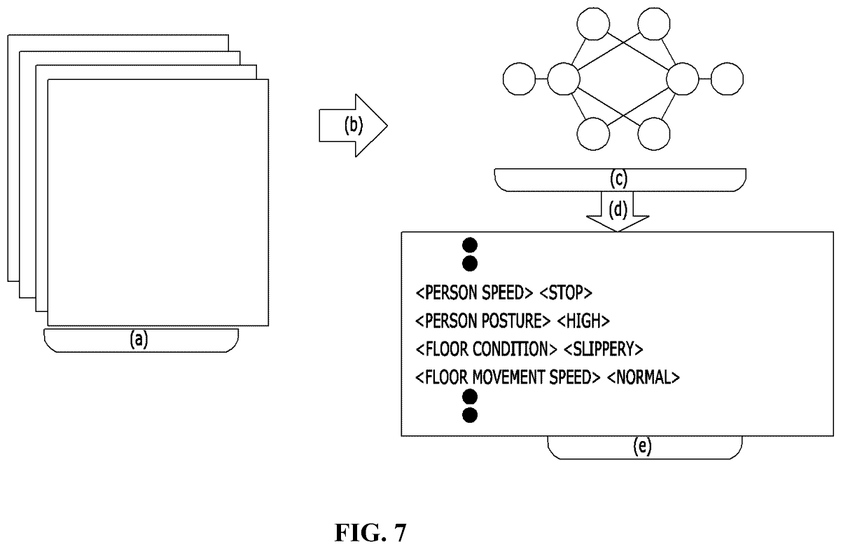

FIG. 7 is a diagram schematically illustrating an example of ontology application of the method for unstructured data analysis based on artificial intelligence according to one embodiment of the present disclosure.

Referring to (a) of FIG. 7, the present apparatus 100 may receive data through the user interface provided to the user terminal 200. For example, the received data may include JSON data. In addition, referring to (b) of FIG. 7, the present apparatus 100 may transmit the received data to a pre-installed data visualization solution. In addition, referring to (c) of FIG. 7, the data visualization solution may include the Cayley.io data visualization open-source solution. In addition, referring to (d) of FIG. 7, the present apparatus 100 may control the data visualization solution to perform data serialization on the received data. In addition, referring to (e) of FIG. 7, the present apparatus 100 may generate the graph corresponding to the N-Triple Type based on the data on which data serialization has been performed.

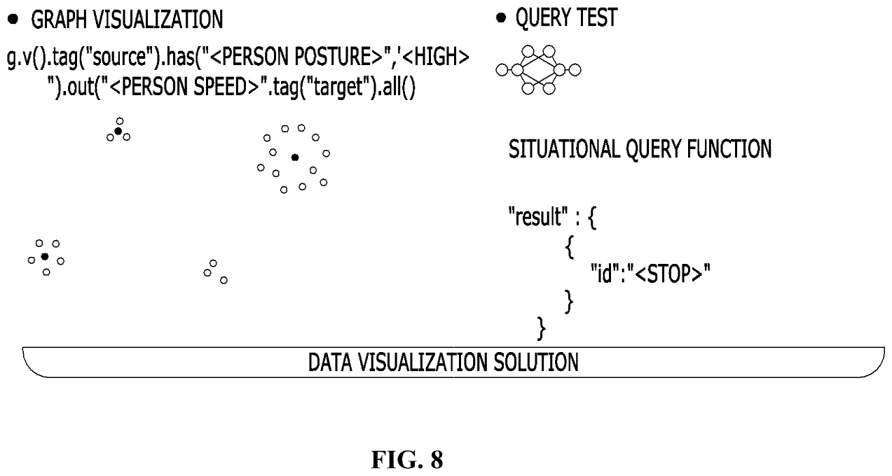

FIG. 8 is a diagram schematically illustrating a first data visualization example corresponding to the ontology application of the method for unstructured data analysis based on artificial intelligence according to one embodiment of the present disclosure.

Referring to FIG. 8, the present apparatus 100 may perform graph visualization, query test, and situational query function setting based on data and data visualization solutions.

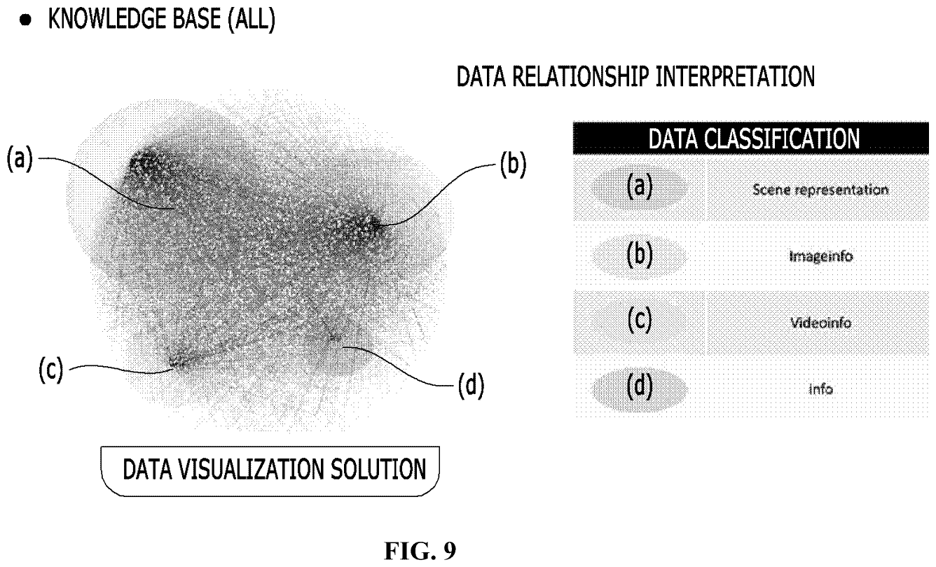

FIG. 9 is a diagram schematically illustrating a second data visualization example corresponding to the ontology application of the method for unstructured data analysis based on artificial intelligence according to one embodiment of the present disclosure.

Referring to FIG. 9, the present apparatus 100 may generate a knowledge graph corresponding to a knowledge base based on a data visualization solution, and classify data by color of the generated knowledge graph for data relationship interpretation as in (a) to (d).

Various supervised learning algorithm models that have been previously known or will be developed in the future may be applied to the present disclosure.

The descriptions of the apparatus and method for unstructured data analysis based on artificial intelligence according to one embodiment of the present disclosure described so far can be understood through the description of the explainable artificial intelligence apparatus and method combining a neural network and symbolic artificial intelligence according to another embodiment of the present disclosure described below, according to the implementation example of the present disclosure. Therefore, even when the content is omitted below, the content described for the apparatus and method for unstructured data analysis based on artificial intelligence according to one embodiment of the present disclosure described above may be similarly applied to the explainable artificial intelligence apparatus and method combining the neural network and symbolic artificial intelligence according to another embodiment of the present disclosure described below.

An explainable artificial intelligence apparatus 100 combining a neural network and symbolic artificial intelligence according to one embodiment of the present disclosure may include a receiving unit that receives unstructured data, an object attribute recognition unit 110 that recognizes an object based on the unstructured data through the neural network and recognizes an attribute based on the object, an event generation unit that generates an event based on a subject, object, and predicate relationship based on the object and attribute recognition, a transmission unit that performs the object and attribute recognition for the unstructured data on an edge computer and transmits the event result to a server, a graph generation unit 130 that generates a graph based on the attribute of the object, a graph extension unit that extends the graph by the unstructured data scene representation from an ontology knowledge base and performs an extension based on inference for the graph through the symbolic artificial intelligence, a graph analysis unit 140 that performs situation recognition and scene-based predictive behavior decision based on the extended graph, an actual situation application unit that applies a conclusion using the graph classification of the situation recognition and scene recognition to an actual situation, a storage unit that stores the result for the actual situation as an ontology along with the prediction result after being applied to the actual situation, a search method providing unit that provides an ontology search method for situation events such as the scene representation, predicted behavior, and class classification result of the predicted behavior, and results of applying the actual situation, and a reconstruction unit that reconstructs a unit graph of the ontology search results into a decision tree based on user request criteria.

For example, the event generation unit may generate the event based on the subject, object, and predicate relationships based on the object and attribute recognition, and the generated event may be applied to edge computing to reduce server load.

In addition, as an example, the transmission unit may perform the object and attribute recognition on unstructured data on the edge computer and transmit the event results to a server, the receiving unit may be the transmission unit, and the ontology management server may be the receiving unit.

In addition, as an example, since the graph extension unit extends the graph by representing the unstructured data scene from the ontology knowledge base, the resolution by the knowledge base may have a significant effect when applying the autonomous traveling and CCTV control.

In addition, as an example, by storing the results for the actual situation as well as the predicted results after the storage unit is applied to the actual situation, as the ontology, the feedback for the application to the actual situation and the basis for applying reinforcement learning may be provided by the present apparatus 100.

In addition, as an example, the reconstruction unit may reconstruct the unit graph of the ontology search results into the decision tree based on user request criteria, and this may be performed by the present apparatus 100 in the form of explainable artificial intelligence.

According to one embodiment of the present disclosure, the present apparatus 100 may provide the data analysis and inference menu to the user terminal 200. For example, the user terminal 200 may access or download and install a web or application program provided by the present apparatus 100, and the data analysis and inference menu may be provided through the accessed web or the installed application.

The present apparatus 100 may include all types of servers, terminals, or devices that transmit and receive data, content, and various communication signals through a network with the user terminal 200 and the external server 300, and have the function of storing and processing data.

In addition, the artificial intelligence-based learning model may be generated through artificial intelligence-based learning such as machine learning and deep learning, but is not limited thereto, and various neural network systems that have been developed or will be developed in the future may be applied.

According to one embodiment of the present disclosure, the explainable artificial intelligence apparatus 100 that combines the neural network and symbolic artificial intelligence may recognize the object for unstructured data using the neural network and recognize the attributes of the object for the recognized object.

For example, the present apparatus 100 may recognize a spherical object in an image using the neural network, and recognize the color blue of the spherical object for the recognized spherical object.

According to one embodiment of the present disclosure, the process of recognizing the attributes of the object based on the unstructured data by the present apparatus 100 may be managed by the RDF or N-Triple Type and implemented in a table format.

According to one embodiment of the present disclosure, the process of recognizing the attributes of the object by the present apparatus 100 may be managed as the RDF or N-Triple Type, and the configuration implemented in a table format may be applied to a predetermined image as a whole and defined as the scene representation.

According to one embodiment of the present disclosure, the RDF or N-Triple Type may be configured as a graph, and graph extension may be performed from an ontology configured as a knowledge base, and the extended graph may be additionally extended through inference.

According to one embodiment of the present disclosure, the present apparatus 100 may input the results of the additionally extended graph into the graph classification artificial intelligence and perform situational recognition and scene-based predictive behavior decisions based on the output results.

According to one embodiment of the present disclosure, the present apparatus 100 inputs the results of the additionally extended graph into the graph classification artificial intelligence, and the output results may be managed by the RDF or N-Triple Type and implemented in a table format.

According to one embodiment of the present disclosure, the RDF or N-Triple Type for managing the output result of graph classification artificial intelligence may be configured as a graph, and graph extension may be performed from the ontology configured as the knowledge base, and the extended graph may be additionally extended through inference.

According to one embodiment of the present disclosure, the situation recognition and scene-based predictive behavior decision performed based on the result output by the graph classification artificial intelligence may be integrated into a configuration where the results of the graph additionally extended by the present apparatus 100 are input into the graph classification artificial intelligence and the output results are managed by the RDF or N-Triple Type and implemented in a table format, and may be integrated into a configuration in which the RDF or N-Triple Type, which manages the output results of the graph classification artificial intelligence, is configured as the graph and extended from the ontology configured as the knowledge base to the graph, and the expanded graph is additionally expanded through inference.

According to one embodiment of the present disclosure, when there is a problem in the configuration in which the performed situation recognition and scene-based predictive behavior decisions are integrated based on the results output by the graph classification artificial intelligence, the present apparatus 100 may reconstruct the integrated graph into the decision tree from input to output, thereby making it possible to explain the recognition process of the artificial intelligence.

According to one embodiment of the present disclosure, the integrated result of the situation recognition and scene-based predictive behavior decision performed based on the results output by the graph classification artificial intelligence may be the structure searchable using the query from the ontology management program.

For example, the integrated results of the situation recognition and scene-based predictive behavior decision performed based on the results output by the graph classification artificial intelligence may be used to search for and summarize the results of scene behaviors using the query from the ontology management program.

A control method of the explainable artificial intelligence apparatus 100 that combines the neural network and symbolic artificial intelligence according to one embodiment of the present disclosure may include a step in which a receiving unit receives unstructured data, a step in which an object attribute recognition unit recognizes an object based on the unstructured data through the neural network and recognizes an attribute based on the object, a step in which an event generation unit generates an event based on a subject, object, and predicate relationship based on the object and attribute recognition, a step in which a transmission unit performs the object and attribute recognition for the unstructured data on an edge computer and transmits the event result to a server, a step in which a graph generation unit 130 generates a graph based on the attribute of the object, a step in which a graph extension unit extends the graph by the unstructured data scene representation from an ontology knowledge base and performs an extension based on inference for the graph through the symbolic artificial intelligence, a step in which a graph analysis unit performs situation recognition and scene-based predictive behavior decision based on the extended graph, a step in which an actual situation application unit applies a conclusion using the graph classification of the situation recognition and scene recognition to an actual situation, a step in which a storage unit stores the result for the actual situation as an ontology along with the prediction result after being applied to the actual situation, a step in which a search method providing unit provides an ontology search method for situation events such as the scene representation, predicted behavior, and class classification result of the predicted behavior, and results of applying the actual situation, and a step in which a reconstruction unit reconstructs a unit graph of the ontology search results into a decision tree based on user request criteria.

Below, the operating flow of the present disclosure will be described based on the detailed explanation above.

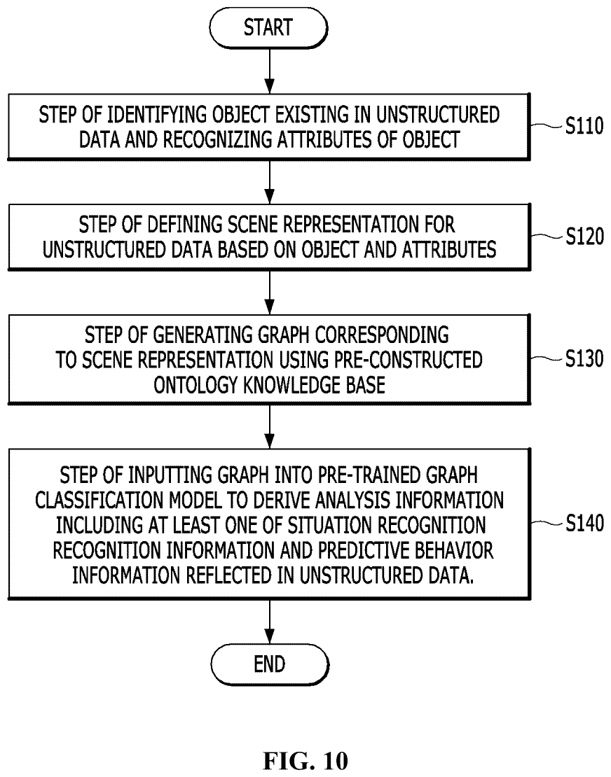

FIG. 10 is a flowchart of an operation for the method for controlling the apparatus 100 for unstructured data analysis based on artificial intelligence according to one embodiment of the present disclosure.

The method for unstructured data analysis based on artificial intelligence (control method of the apparatus for unstructured data analysis based on artificial intelligence) illustrated in FIG. 10 may be performed by the apparatus for unstructured data analysis based on artificial intelligence described above. Therefore, even when the content is omitted below, the content described for the apparatus for unstructured data analysis based on artificial intelligence may be similarly applied to the descriptions of the method for unstructured data analysis based on artificial intelligence.

Referring to FIG. 10, the method for unstructured data analysis based on artificial intelligence may include Steps S110 to S140.

In Step S110, the present apparatus 100 may identify the object existing in the unstructured data and recognize the attributes of the object.

Next, in Step S120, the present apparatus 100 may define the scene representation for the unstructured data based on the object and attributes.

Next, in Step S130, the present apparatus 100 may generate the graph corresponding to the scene representation using the pre-constructed ontology knowledge base.

Next, in Step S140, the present apparatus 100 may input the graph into the pre-trained graph classification model to derive the analysis information including at least one of the situation recognition information and predictive behavior information reflected in the unstructured data.

In the above description, Steps S110 to S140 may be further divided into additional steps or combined into fewer steps, depending on the implementation example of the present disclosure. In addition, some steps may be omitted as needed, and the order between the steps may be changed.

The method for unstructured data analysis based on artificial intelligence according to one embodiment of the present disclosure may be implemented in the form of program commands that can be executed through various computer means and recorded on a computer-readable medium. The computer-readable medium may include program commands, data files, data structures, or the like, alone or in combination. The program commands recorded on the medium may be those specially designed and configured for the present disclosure or may be those known to and usable by those skilled in the art of computer software. Examples of the computer-readable recording medium include magnetic media such as hard disks, floppy disks, and magnetic tapes, optical media such as CD-ROMs and DVDs, magneto-optical media such as floptical disks, and hardware devices specially configured to store and execute program commands such as ROMs, RAMs, and flash memories. Examples of the program commands include not only machine language codes generated by a compiler, but also high-level language codes that can be executed by a computer using an interpreter, or the like. The hardware devices may be configured to operate as one or more software modules to perform the operations of the present disclosure, and vice versa.

In addition, the aforementioned method for unstructured data analysis based on artificial intelligence may also be implemented in the form of a computer program or application executed by a computer and stored in a recording medium.

The descriptions of the present disclosure are for illustrative purposes, and those skilled in the art will understand that the present disclosure can be easily modified into other specific forms without changing the technical idea or essential features of the present disclosure. Therefore, it should be understood that the embodiments described above are exemplary in all respects and not restrictive. For example, each component described as a single component may be implemented in a distributed manner, and likewise, components described as distributed may be implemented in a combined form.

The scope of the present disclosure is indicated by the claims described below rather than the detailed description above, and all changes or modifications derived from the meaning and scope of the claims and their equivalent concepts should be interpreted as being included in the scope of the present disclosure.

What is claimed is:

1. A method for unstructured data analysis based on artificial intelligence, the method comprising:
(a) identifying an object existing in unstructured data and recognizing attributes of the object;
(b) defining a scene representation for the unstructured data based on the object and the attributes;
(c) generating a graph corresponding to the scene representation by using a pre-constructed ontology knowledge base; and
(d) inputting the graph to a pre-trained graph classification model so as to derive analysis information including at least one of situation recognition information and predictive behavior information reflected in the unstructured data.

2. The method of claim 1, wherein in the (b), the attributes are reflected in the scene representation based on a data type including at least one of a resource description framework (RDF), N-Triple, and a table.

3. The method of claim 1, further comprising updating the scene representation based on the analysis information.

4. The method of claim 3, further comprising reflecting the scene representation updated using the analysis information into the ontology knowledge base.

5. The method of claim 1, further comprising (e) receiving a user search input, searching for the analysis information corresponding to the user search input from the ontology knowledge base, and providing partial data of the unstructured data matching the user search input.

6. The method of claim 1, wherein the unstructured data includes image data including a plurality of frames, and
the (a) to (d) are performed independently for each of the plurality of frames.

7. The method of claim 5, wherein the unstructured data includes image data, and the partial data includes a summary image or a description image that matches the user search input.

8. An apparatus for unstructured data analysis based on artificial intelligence, the apparatus comprising:
an object attribute recognition unit that identifies an object existing in unstructured data and recognizes attributes of the object;
a knowledge representation unit that defines a scene representation for the unstructured data based on the object and the attributes;
a graph generation unit that generates a graph corresponding to the scene representation by using a pre-constructed ontology knowledge base; and
a graph analysis unit that inputs the graph to a pre-trained graph classification model so as to derive analysis information including at least one of situation recognition information and predictive behavior information reflected in the unstructured data.

9. The apparatus of claim 8, wherein the knowledge representation unit reflects the attributes in the scene representation based on a data type including at least one of a resource description framework (RDF), N-Triple, and a table.

10. The apparatus of claim 8, wherein the knowledge representation unit updates the scene representation based on the analysis information.

11. The apparatus of claim 10, further comprising an ontology management unit that reflects the scene representation updated using the analysis information into the ontology knowledge base.

12. The apparatus of claim 8, further comprising a search performing unit that receives a user search input, searches for the analysis information corresponding to the user search input from the ontology knowledge base, and provides partial data of the unstructured data matching the user search input.

13. The apparatus of claim 8, wherein the unstructured data includes image data including a plurality of frames.

14. The apparatus of claim 12, wherein the unstructured data includes image data, and the partial data includes a summary image or a description image that matches the user search input.

15. A computer-readable recording medium having recorded thereon a program for executing the methods of claim 1 on a computer.
